(19) United States
(12) Patent Application Publication
(10) Pub. No.: US 2023/0128777 A1
(43) Pub. Date: Apr. 27, 2023

(54) SEMICONDUCTOR INTEGRATED CIRCUIT

(71) Applicant: SAMSUNG ELECTRONICS CO., LTD., SUWON-SI (KR)

(72) Inventors: JUN HONG PARK, SEOUL (KR); HO NAM LEE, SEOUL (KR); YOUNG HO CHOI, SEONGNAM-SI (KR)

(21) Appl. No.: 17/839,278

(22) Filed: Jun. 13, 2022

(30) Foreign Application Priority Data
Oct. 21, 2021 (KR) 10-2021-0141296

(51) Int. Cl. G09G 3/00; G09G 3/32

(52) U.S. Cl. CPC G09G 3/006; G09G 3/32; G09G 2310/08; G09G 2370/16

(57) ABSTRACT

A display drive device includes a first Intellectual Property (IP) module, a second IP module, a timing controller which includes a wireless communication module that is wirelessly connected to a test device, and a non-volatile memory. The timing controller receives setting data and stops executing a current operation when receiving the setting data. The non-volatile memory stores the setting data that is received from the timing controller.

This application claims priority from Korean Patent Application No. 10-2021-0141296 filed on Oct. 21, 2021, in the Korean Intellectual Property Office, the disclosure of which is incorporated herein by reference in its entirety.

### BACKGROUND

### 1. Field of the Disclosure

The disclosure relates to a semiconductor integrated circuit that can be tested using a wireless communication.

### 2. Description of the Related Art

Non-defective products and defective products of semiconductor integrated circuits are distinguished through tests before packaging and after packaging. Before packaging, each IP (Intellectual Property) can be tested, and if a defect is found through the test, the product may be physically separated and the cause of the defect may be solved. However, after packaging, test of individual IPs is not easy, unless a wired connection is provided for each IP.

To transmit test data and receive test results, a packaged system-on-chip needs to have test input/output pins for wired channel connections. Also, even if the test input/output pins are provided, there is a problem that the test using wired communication for application to a large quantity of semiconductor integrated circuits or electronic devices with built-in semiconductor integrated circuits is extremely time-consuming and labor-intensive.

### SUMMARY

Aspects of the disclosure provide a semiconductor integrated circuit that may access and debug data.

One embodiment of the disclosure provides a display drive device comprising a first IP (Intellectual Property) module, a second IP module, a timing controller which includes a wireless communication module that is wirelessly connected to a test device and sends and receives setting data and which stops a currently executing operation and sends the setting data when receiving the setting data. A non-volatile memory stores the setting data received from the timing controller.

Another embodiment of the disclosure provides a test device comprising a wireless communication module which wirelessly communicates with a timing controller in a display drive. The wireless communication module sends setting data to the timing controller, receives reply data from the timing controller, and checks a test result.

Another embodiment of the disclosure provides a semiconductor integrated circuit comprising a timing controller which wirelessly sends and receives setting data from a test device and a non-volatile memory which receives and stores the setting data from the timing controller.

However, aspects of the disclosure are not restricted to those set forth herein. The above and other aspects of the disclosure will become more apparent to one of ordinary skill in the art to which the disclosure pertains by referencing the detailed description given below.

### BRIEF DESCRIPTION OF THE DRAWINGS

FIG. 1 is a block diagram which shows a test device and a semiconductor integrated circuit according to some embodiments.

FIG. 2 is a block diagram which shows the test device and the semiconductor integrated circuit (System on Chip) according to some embodiments.

FIG. 3 is a timing diagram for explaining the operation of the semiconductor integrated circuit of FIG. 1 according to some embodiments.

FIG. 4 is a flowchart for explaining the method for operating the semiconductor integrated circuit of FIG. 2 according to some embodiments.

FIG. 5 is a diagram for explaining a memory access operation between the timing controller and the non-volatile memory according to some embodiments.

FIG. 6 is a conceptual diagram for explaining a structure of data sent by the test device according to some embodiments.

FIG. 7 is a flowchart for explaining the method for operating the semiconductor integrated circuit according to some embodiments.

FIG. 8 is a block diagram showing a test device and a semiconductor integrated circuit according to some embodiments.

FIG. 9 is a flowchart for explaining a method for operating the semiconductor integrated circuit of FIG. 8 according to some embodiments.

FIG. 10 is a diagram which shows the electronic device according to some embodiments.

FIG. 11 is a diagram which shows the display drive device and display panel according to some embodiments.

FIG. 12 is an exploded perspective view which shows the display device according to some embodiments.

FIG. 13 is a perspective view which shows a display device according to some embodiments.

FIG. 14 is a block diagram of an electronic device in a network environment according to some embodiments.

### DETAILED DESCRIPTION OF THE EMBODIMENTS

Hereinafter, various embodiments will be described referring to the accompanying drawings.

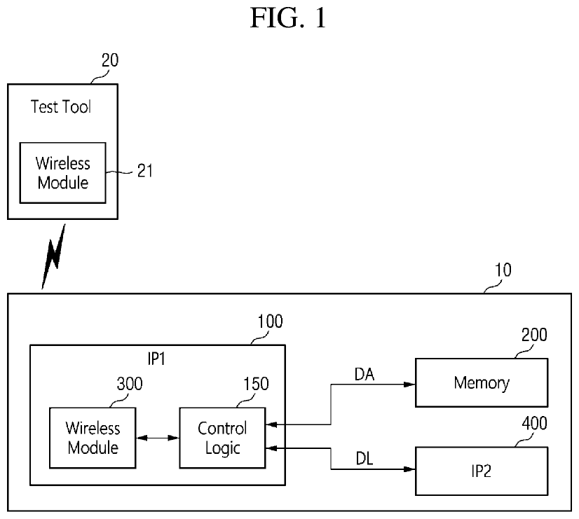

FIG. 1 is a block diagram which shows a test device and a semiconductor integrated circuit according to some embodiments.

Referring to FIG. 1, a semiconductor integrated circuit 10 includes a plurality of components placed on a printed circuit board. According to some embodiments, the plurality of components may be placed on a single printed circuit board, and according to another embodiment, they may be placed on two or more printed circuit boards.

According to some embodiments, the semiconductor integrated circuit 10 may be a logic semiconductor, a system semiconductor, a control semiconductor, or the like. For example, the semiconductor integrated circuit may be a display drive circuit, a touch drive circuit or the like.

According to some embodiments, the semiconductor integrated circuit 10 may include a plurality of IPs (Intellectual Property) 100 and 400, a non-volatile memory device 200 that stores data utilized in the plurality of IPs, and the like.

According to some embodiments, the semiconductor integrated circuit 10 may be a semiconductor integrated circuit that is built in a mobile device, a display device, and various electronic devices.

A test device 20 is a device for testing the operation of the semiconductor integrated circuit 10 and may wirelessly communicate with the semiconductor integrated circuit 10. According to some embodiments, the setting data is input to the test device 20 through a computer, a mobile terminal or the like, and the test device 20 may transfer the received setting data to the semiconductor integrated circuit 10 by wireless communication. Alternatively, according to some embodiments, the user inputs the test data to the test device 20 through the input terminal and the test device 20 may transfer the test data to the semiconductor integrated circuit 10 by wireless communication.

To perform wireless communication, the test device 20 may include a test wireless communication module 21 and the semiconductor integrated circuit 10 may include a wireless communication module 300. The test device 20 and the semiconductor integrated circuit 10 may support a M2M (machine to machine) communication, a D2D (device to device) communication, and the like. According to some embodiments, the test wireless communication module 21 and the wireless communication module 300 may communicate through a short-range wireless communication network. The short-range wireless communication network includes communication system such as Bluetooth™ WiFi Direct, NFC (Near field communication), Zigbee™, Z-wave™, 6LoWPAN™ or IrDA (infrared data association) according to some embodiments.

According to some embodiments, the semiconductor integrated circuit 10 may include a first IP module 100 and a non-volatile memory device 200. Here, the first IP module 100 and the non-volatile memory device 200 may be included in the same printed circuit board according to some embodiments or each may be included in different printed circuit boards and electrically connected.

According to various embodiments, the first IP module 100 may be a processor that controls the overall operation of the semiconductor integrated circuit 10 or may be a processor that controls one operation of the specific components of the semiconductor integrated circuit 10. For example, the first IP module 100 may be a timing controller, a power controller, an application processor, a neural processor, or a graphic processor. However, the first IP module 100 and the second IP module 400 are processors that perform different functions from each other.

According to some embodiments, the first IP module 100 may include a wireless communication module 300 and a control logic 150. The wireless communication module 300 may send and receive data to and from the test wireless communication module 21 of the test device 20 by wireless communication. The data may include firmware for a plurality of components built in the semiconductor integrated circuit 10, SFR (Special Function Register) information, data necessary for the operation of at least one of the plurality of components, and the like.

When receiving the data from the test device 20 according to some embodiments, the control logic 150 accesses the non-volatile memory device 200 and sends the data. The control logic 150 may transmit the data stored in the non-volatile memory device 200 or error information of data (e.g., CRC check result) at the request of the test device 20 or by self-determination as reply data through the wireless communication module 100, according to some embodiments.

The control logic 150 may send the data received from the test device 20 to another IP module (e.g., IP2) 400 according to some embodiments. The control logic 150 may read the data stored in the non-volatile memory device 200 and transmit it to the second IP module 400 according to some embodiments (DL). According to some embodiments, the second IP module 400 may operate by loading the data received from the first IP module 100. According to some embodiments, the second IP module 400 may inform the first IP module 100 of the result of loading the received data. As an example, it is possible to inform the first IP module 100 whether the received data is loaded successfully or fails to load. As another example, the second IP module 400 may communicate information (e.g., firmware version, information about the finally updated content, etc.) of the loaded data to the first IP module 100. The first IP module 100 may communicate the data loading result to the test device 20 on the basis of reply contents of the second IP module 400.

The non-volatile memory device 200 is accessed by the first IP module 100 (DA). The non-volatile memory device 200 writes and stores the data or reads the stored data and sends it to the first IP module 100. The non-volatile memory device 200 is not accessed by the second IP module 400. As described above, the non-volatile memory device 200 may be placed on a printed circuit board different from that of the first IP module 100 or may be placed on the same printed circuit board.

According to some embodiments, the data sent by the test device 20 to the semiconductor integrated circuit 10 may include data for testing at least one of a plurality of components in the semiconductor integrated circuit 10, firmware of the components, SFR (special function registration) information, or the data about the operational information of the components.

According to some embodiments, the non-volatile memory device 200 may include a memory controller and a non-volatile memory. Although the non-volatile memory may include, for example, a NAND-type Flash Memory, an MRAM (Magnetic RAM), a Spin-Transfer Torque MRAM, a Conductive bridging RAM (CBRAM), an FeRAM (Ferroelectric RAM), a PRAM (Phase RAM), a Resistive Memory (Resistive RAM), a Nanotube RAM, a Polymer RAM (PoRAM), a Nano Floating Gate Memory (NFGM), a holographic memory, a molecular electronics memory, an insulator resistance change memory, and the like, but the embodiments are not limited to these examples.

According to some embodiments, the non-volatile memory device 200 may be an embedded memory device that is built in the semiconductor integrated circuit 10. For example, the non-volatile memory device 200 may be an eMMC (embedded Multi-Media Card), an embedded UFS (Universal Flash Storage) memory device, a ROM (read only memory), an electrically erasable programmable read only memory (EEPROM), or a magnetic disc storage device.

The control logic 150 may receive error information for checking whether the data transmission is performed correctly when the data is sent to the non-volatile memory device 200. For example, the data to be sent includes CRC (Cyclical Redundancy Check, hereinafter CRC) information, and the non-volatile memory device 200 may write the data and then send the CRC result of the stored data to the control logic 150.

According to some embodiments, the control logic 150 may re-transmit the setting data to the non-volatile memory 200 according to the CRC result for the setting data.

After that, the control logic 150 may send the data, in which no error occurs or an error is corrected, to the second IP module 400.

The test device 20 first sends an access signal, checks the user authority, and then is paired with the semiconductor integrated circuit 10. The semiconductor integrated circuit 10 stops the currently executing operation when receiving the access signal and receives the setting data after being paired with the test device 20.

According to some embodiments, the control logic 150 performs a CRC (Cyclic Redundancy Check) operation of the setting data. When the error is not corrected even if the re-transmission of the setting data exceeds the preset number of times (CRC File), the initial setting data pre-stored in the non-volatile memory device 200 may be read. At this time, the initial setting data may be data that is not sent from the test device 20, but is related to the basic setting values stored in the non-volatile memory device 200 in advance.

The semiconductor integrated circuit 10 may include a second IP module 400. The second IP module 400 according to various embodiments may be a processor that controls one operation of a specific component of the semiconductor integrated circuit 10. For example, the second IP module 400 may be a timing controller, a power management circuit, an application processor, a neural processor, or a graphics processor. However, the first IP module 100 and the second IP module 400 are processors that execute different functions from each other.

According to some embodiments, the second IP module 400 may be an IP that operates by loading the setting data received from the first IP module 100. The setting data loaded at this time may include one of the firmware of the second IP module 400, SFR information, or information related to the operation.

The first IP module 100 may communicate error information of setting data to be written in the non-volatile memory 200, setting data read from the non-volatile memory 200, or error check information about setting data loaded into the second IP module 400 to the test device 20 as reply data. The test device 20 may check whether the semiconductor integrated circuit 10 is operating normally and where an error occurs, on the basis of the reply data sent from the first IP module 100.

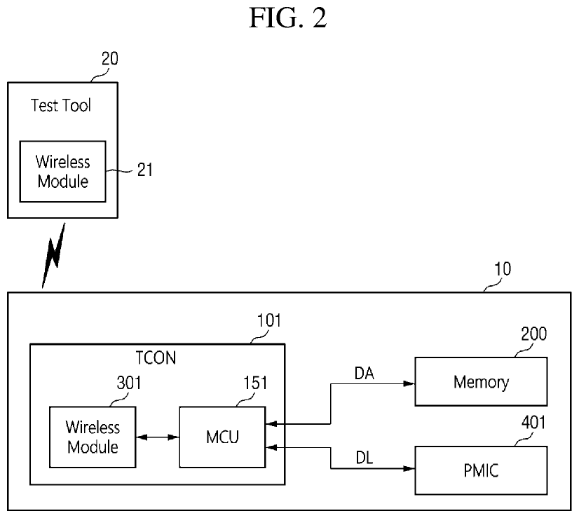

FIG. 2 is a block diagram which shows the test device and the semiconductor integrated circuit (System on Chip) according to some embodiments. For convenience of explanation, repeated explanation of FIG. 1 will be omitted.

Referring to FIG. 2, according to some embodiments, the semiconductor integrated circuit 10 may be an OLED display module, an LCD display module or another display module.

In the embodiment of FIG. 2, the semiconductor integrated circuit 10 includes a timing controller 101, a non-volatile memory device 200, and a PMIC 401.

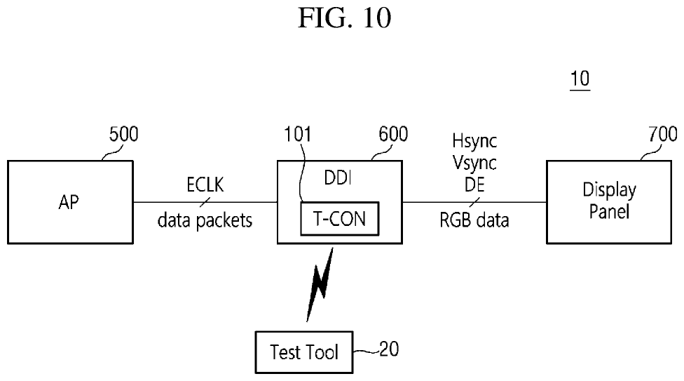

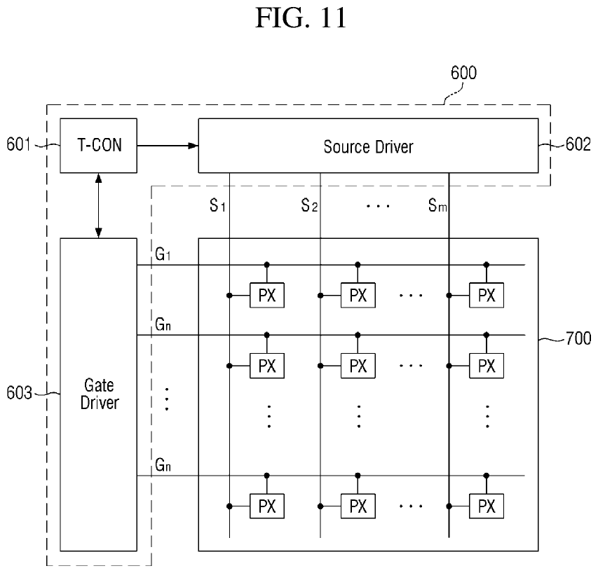

The timing controller 101 may generate a drive control signal which is provided to the drive circuit of the display panel (display panel of FIGS. 10 to 13). For example, a scan drive control signal, a data drive control signal, a light emission drive control signal, and the like are generated. The drive control signal controls the output timing of the drive signal (e.g., the scan drive signal, the data drive signal, and the light emission drive signal).

The timing controller 101 may include a wireless communication module 301 and an MCU (Main Control Unit) 151. As described of FIG. 1, the wireless communication module 301 performs short-range wireless communication with the test device 20 and the timing controller 101 and the test device 20 send and receive the data.

According to some embodiments, the MCU 151 sends the data received from the test device 20 to the non-volatile memory device 200 and the non-volatile memory device 200 writes and stores the data. According to some embodiments, the non-volatile memory device 200 may store the data received from the MCU 151 and may previously store the initial data required for the operation of each component of the display module 10 according to some embodiments.

The MCU 151 and the non-volatile memory device 200 may monitor whether an error has occurred in the data sent and received from each other. Specifically, when the MCU 151 and the non-volatile memory device 200 send and receive data, the presence or absence of an error occurrence may be checked by comparing the CRC information of the sent data with the CRC information of the data stored in the non-volatile memory device 200.

According to some embodiments, when an error occurs in the sent and received data, the MCU 151 may re-send (when sending) the data to the non-volatile memory device 200 or re-read the data from the non-volatile memory device 200 (when receiving). Further, a communication of whether the error occurs and is corrected may be sent to the test device 20. According to some embodiments, the test device 20 may determine the performance or the presence or absence of defects of the semiconductor integrated circuit 10 on the basis of the reply information.

According to some embodiments, when the error correction attempt of the sent and received data fails (e.g., when the re-sending or re-read exceeds the number of threshold times), the MCU 151 reads the initial data previously stored in the non-volatile memory device 200 and may load the initial data when the semiconductor integrated circuit 10 is driven.

According to some embodiments, the MCU 151 may read the setting data stored in the non-volatile memory 200 and load the setting data when the timing controller 101 is driven. Alternatively, according to some embodiments, the MCU 151 may read the setting data stored in the non-volatile memory 200 and send the setting data to the PMIC 401. The PMIC 401 may be driven on the basis of the data received from the MCU 151.

The MCU 151 may send the reply data of the operating status of the semiconductor integrated circuit 10 to the test device 20 through the wireless communication module 301. The test device 20 may determine the presence or absence of the normal operation and the performance of the semiconductor integrated circuit 10 on the basis of the reply data.

According to some embodiments, the test device 20 may update the setting data according to the determination result and re-send the setting data to the semiconductor integrated circuit 10.

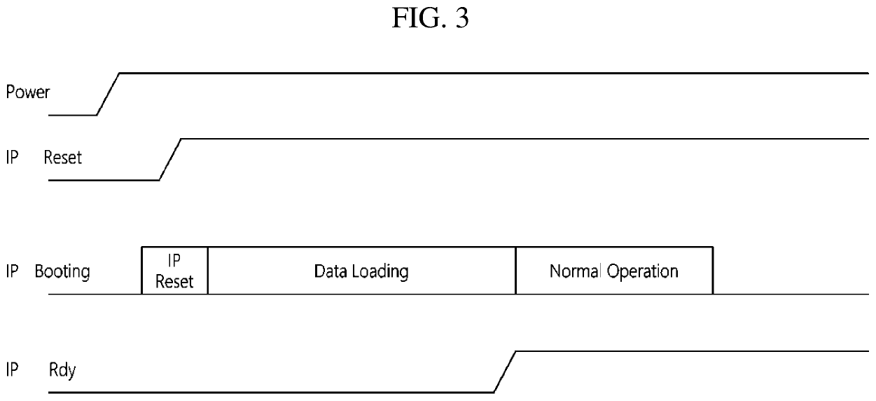

FIG. 3 is a timing diagram for explaining the operation of the semiconductor integrated circuit of FIG. 1 according to some embodiments.

Referring to FIGS. 1 and 3, when the power is turned on in the semiconductor integrated circuit 10 (Power Logical High), the first IP module 100 is reset, while changing from an IP reset logic low to logic high.

After the first IP module 100 is reset, data is received by the test device 20 by wireless communication and the received data is loaded into each of the first IP module 100, the non-volatile memory device 200, and the other second IP module 400 (IP Reset and Data loading in IP Booting).

For example, the received data is stored in the non-volatile memory device 200 or the data stored in the non-volatile memory device 200 is read and sent to the second IP module 400 and the data is loaded in the second IP module 400.

When data is loaded into the components included in the semiconductor integrated circuit 10 or the driving is completely prepared, while a ready signal (IP Rdy) changes from logic low to logic high, the semiconductor integrated circuit 10 is normally driven (Normal operation).

According to some embodiments, the semiconductor integrated circuit 10 may send information about a data error occurrence and correction at the time of data loading, operation data at the time of normal operation, and the like as reply data to the test device 20. For example, the operation data of the first IP module 100, a data access result with respect to the non-volatile memory device 200, a data loading result (success or failure) in the second IP module 400, the data information, and the like may be sent to the test device 20 through the wireless communication module 300 in the first IP module 100.

Accordingly, since the semiconductor integrated circuit 10 can be tested by sending and receiving the data wirelessly, the semiconductor integrated circuit 10 can be tested without external packaging or damage, it is possible to check the presence or absence of an abnormal operation, and it is possible to easily check the location of data corruption or the like on the basis of a data header information and error information. In addition, since the semiconductor integrated circuit 10 can be tested without physically performing the wired connection, it is possible to test a large quantity of semiconductor integrated circuits at the same time.

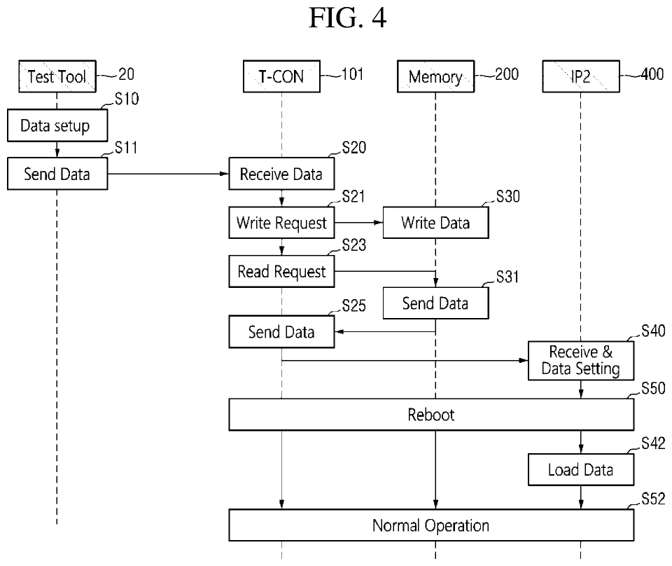

FIG. 4 is a flowchart for explaining the method for operating the semiconductor integrated circuit of FIG. 2 according to some embodiments.

Referring to FIG. 4, first, the test device 20 sets the setting data for sending to the semiconductor integrated circuit 10 (S10). According to some embodiments, the setting data may include data for testing at least one of a plurality of components in the semiconductor integrated circuit 10, firmware FW of the component, SFR (special function register) information (SFR maker data), or setting data related to the operational information of the component.

The test device 20 sends the setting data through the test wireless communication module 21 (S11). According to some embodiments, the test device 20 may send an access signal before sending the setting data. The semiconductor integrated circuit 10 may check the user authority of the test device 20 based on the access signal and may perform pairing when the access authority is checked. According to some embodiments, the timing controller of the semiconductor integrated circuit 10 may stop the currently executing operation when pairing is performed.

When a timing controller 101 in the semiconductor integrated circuit 10 receives the setting data through the wireless communication module 301 (S20), the timing controller 101 accesses the non-volatile memory device 200 and sends a write request for the setting data (S21).

Upon receiving the write request and the setting data, the non-volatile memory device 200 stores the setting data at an arbitrary preset address (S30). According to some embodiments, the timing controller checks whether there is an error in the stored setting data (e.g., CRC operation).

After that, the timing controller 101 makes a setting data read request to the non-volatile memory device 200 (S23), and the non-volatile memory device 200 reads the setting data corresponding to the read request and sends it to the timing controller 101. (S31). The timing controller 101 sends the data to the component (e.g., the timing controller itself or the second IP) to which the setting data is to be loaded, referring to the header information of the data (S25).

In an embodiment, the data may be related to firmware, SRF information, or operational information for an IP2 (e.g., PMIC of FIG. 2) 401. In this case, the timing controller 101 sends the setting data received from the non-volatile memory device 200 to the IP (e.g., PMIC of FIG. 2) 401 (S25). IP2 receives the data, updates the settings based on the data (S40), and after the chip rebooting (S50) of the semiconductor integrated circuit 10, loads with the updated environment (S42), and performs a normal operation (S52).

In another embodiment, the setting data may be related to firmware for the control logic 150 of the timing controller 101, SRF information, or operational information. In this case, the control logic 150 sets the setting data by itself, not in the step S40, and loads with the setting data after the semiconductor integrated circuit 10 is rebooted; and the timing controller 101 performs the normal operation.

For convenience of description, although the IP 400 is shown as a single component, according to various embodiments, the IP 400 may be a plurality of IPs, each having a different function from the timing controller 101.

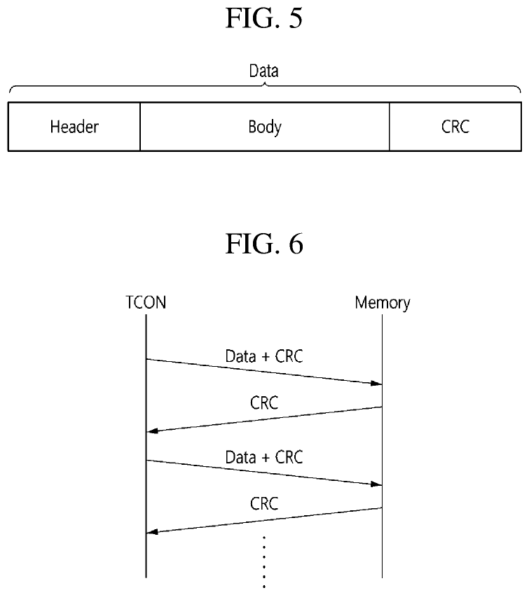

FIG. 5 is a conceptual diagram for explaining a structure of data sent by the test device according to some embodiments, and FIG. 6 is a diagram for explaining a memory access operation between the timing controller and the non-volatile memory according to some embodiments.

Referring to FIGS. 5 and 6, when an error occurs in the data that are sent and received between the test device 20 and the semiconductor integrated circuit 10, the semiconductor integrated circuit 10 may not be booted up. In order to maintain data integrity inside the semiconductor integrated circuit 10, the data may include header information, body information, and CRC information.

According to some embodiments, the header information may include at least one of a target component (e.g., the target IP to which the corresponding data is to be loaded) in the semiconductor integrated circuit 10, data size information (target write/read size), and a target address to be accessed (Read write start address).

According to some embodiments, the body information may include setting data required to drive the semiconductor integrated circuit 10, for example, data for testing at least one of a plurality of components in the semiconductor integrated circuit 10, the firmware FW of the component, SFR (special function register) information (SFR maker data), or data related to the operational information of the component.

According to some embodiments, the CRC information may include information for checking whether data between the test device 20 and the semiconductor integrated circuit 10 or between the first IP module 100 and the second IP module 400 is correctly written/read without an error.

For example, when the first IP module 100 is the timing controller 101, the timing controller sends the data including CRC information to the non-volatile memory device together with the write request, and the non-volatile memory device calculates the CRC of the written data and sends a comparison result with the calculated CRC. The timing controller may perform a control so that no booting-up is performed while an abnormal value is written in the non-volatile memory, according to this comparison result.

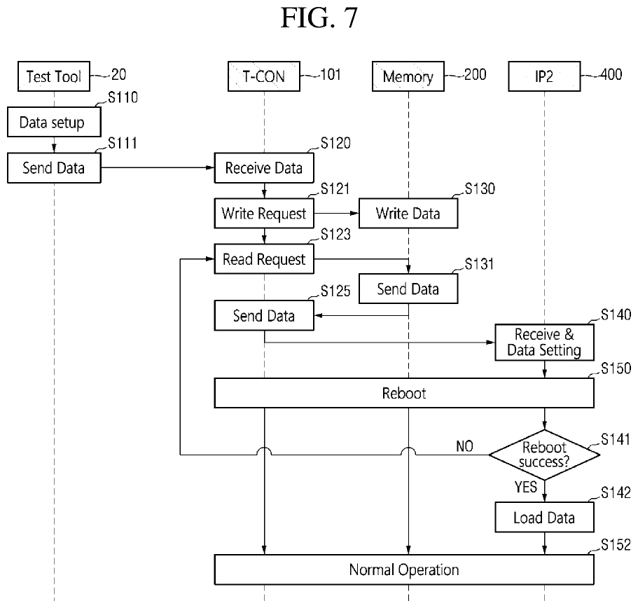

FIG. 7 is a flowchart for explaining the method for operating the semiconductor integrated circuit according to some embodiments. Since steps S110 to S140 of FIG. 7 overlap steps S10 to S40 of FIG. 4, the description thereof will not be provided.

According to some embodiments, after the data is loaded into the second IP module 400 (S140), when the semiconductor integrated circuit 10 is re-booted up (S150), if there is a problem with the loaded data, the booting-up may not be performed correctly.

When the re-booting fails due to a problem such as an error in data (S141), according to some embodiments, the timing controller 101 resends the read request to the non-volatile memory device (S123) and may repeat the steps S123 to S140.

Although not shown, according to some embodiments, even when the timing controller 101 re-reads data from the non-volatile memory device 200 and loads the data into the IP2 400, if the re-booting is not performed correctly (S141, No), the timing controller 101 may inform the test device 20 of the status information of the semiconductor integrated circuit 10.

According to some embodiments, when the re-booting fails (S141, No), the timing controller 101 sends a read request to read the initial data pre-stored in the non-volatile memory device 200 (that is, the preset firmware FW of the component, SFR (special function register) information (SFR maker data), etc.), rather than the data sent by the test device 20 (S123), and sends the read initial data (S131, S125) to IP2 400 to be loaded in IP2 400 (S140, S150, S141, and S142). Thereafter, the timing controller 101 performs a normal operation (S152).

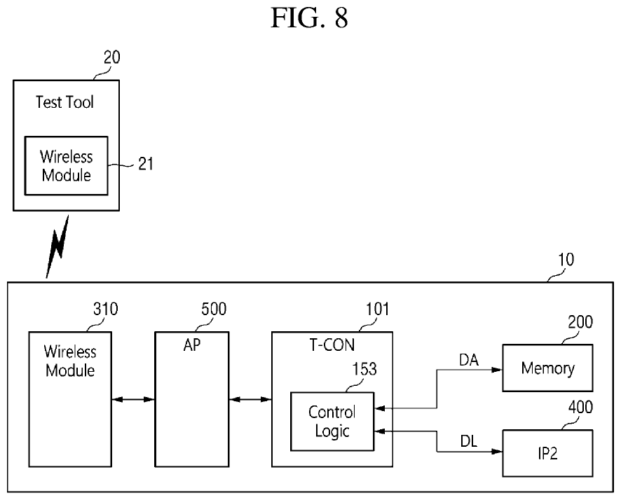

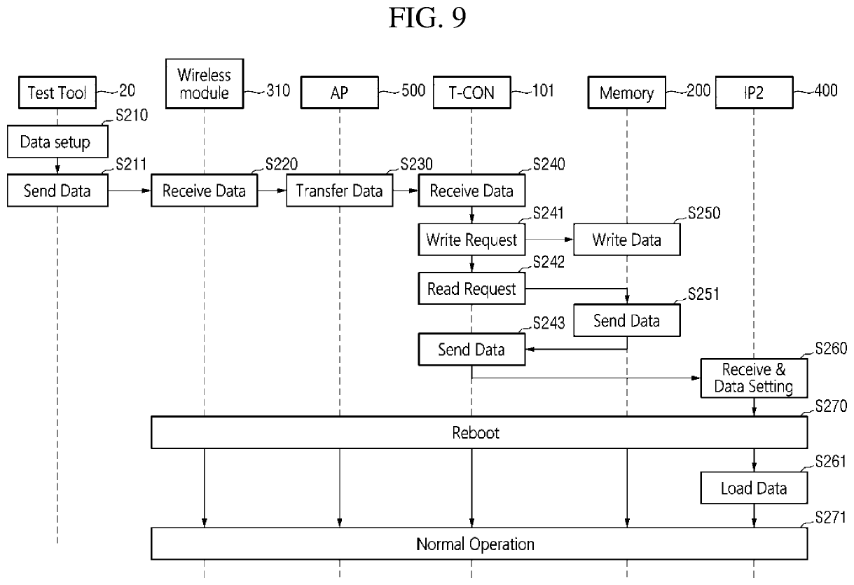

FIG. 8 is a block diagram showing a test device and a semiconductor integrated circuit according to some embodiments, and FIG. 9 is a flowchart for explaining a method for operating the semiconductor integrated circuit of FIG. 8 according to some embodiments. For convenience of explanation, repeated explanation of FIGS. 1 and 2 will be omitted.

Referring to FIGS. 8 and 9, the semiconductor integrated circuit 10 according to some embodiments may be an electronic device or a display drive device. The semiconductor integrated circuit 10 may include a wireless communication module 310, an AP (application processor) 500, a first IP (not illustrated), a non-volatile memory device 200, and a second IP module 400. According to some embodiments, another processing unit, for example, a CPU (Central Processing Unit), an NPU (Neural Processing Unit), a GPU (Graphic Processing Unit), or an SoC (System On Chip) in which various functions are embedded into one may be adopted instead of the AP 500, without being limited to the AP 500.

The wireless communication module 310 may be a communication module included in the electronic device. According to some embodiments, the wireless communication module 310 may be a communication module capable of performing not only short-range wireless communication but also long-range wireless communication.

Unlike the embodiments of FIGS. 1 and 2, the wireless communication module 310 may be directly connected to the AP 500, and the timing controller 101 may be connected to the wireless communication module 310 through the AP 500.

The test device 20 sets the setting data (S210), and the semiconductor integrated circuit 10 receives the setting data through the wireless communication module 310 (S211). The AP 500 checks the basic information (e.g., the address information included in the header) of the received setting data (S220) and transfers the data to the components (S230).

When the setting data is sent to the timing controller 101 according to some embodiments (S240), the timing controller 101 requests the non-volatile memory device 200 to write the received setting data and stores the setting data (S241, S250). As an example, the data may include data for testing at least one of a plurality of components in the semiconductor integrated circuit 10, firmware FW of the components, SFR (special function register) information (SFR maker data), or data about the operational information of the component.

The timing controller 101 makes a read request to the non-volatile memory device 200 (S242), and the non-volatile memory device 200 reads the setting data corresponding to the read request and sends the setting data to the timing controller 101 (S251). The timing controller 101 sends the data to the component (e.g., the timing controller itself or the second IP module) to which the setting data is to be loaded, referring to the header information of the read setting data (S243).

The component (e.g., IP2 module) receives the setting data, updates the setting (S260), and performs the chip rebooting (S270) of the semiconductor integrated circuit 10, then loads with the updated setting (S261) and performs the normal operation. (S271).

Although not shown, according to some embodiments, if an error occurs when re-booting, the timing controller 101 may read the data again and read the pre-stored initial data, as described of FIG. 7.

FIG. 10 is a diagram which shows the electronic device according to some embodiments.

Referring to FIG. 10, the electronic device 10 may include a processor (or a module including an application processor (AP), a communication processor (CP), a sensor hub or a microcontroller unit (MCU)) 500, a display drive circuit (display driver integration circuit; hereinafter, “DDI”) 600, and a display panel 700.

According to various embodiments, the processor 500 may control the overall operation of the electronic device 10 and control the input and output of data packets having display data according to a clock (e.g., ECLK). Here, the data packets may include display data (RGB data), horizontal sync signal (Hsync), vertical sync signal (Vsync), and/or data activation signal (DE). According to various embodiments, the display drive circuit 600 receives the data packets from the processor 500 through the interface and may output a horizontal sync signal (Hsync), a vertical sync signal (Vsync), a data activation signal (DE), display data (RGB data), and/or a clock (e.g., PCLK). For example, the clock PCLK may be a clock (e.g., ECLK) that is input from the processor 500.

According to an embodiment, the processor 500 and/or the display drive circuit 600 may control various interfaces. For example, the interface may include a mobile industrial interface (MIPI), a mobile display digital interface (MDDI), a serial peripheral interface (SPI), an inter-integrated circuit (I2C), or a compact display port (CDP).

According to an embodiment, the display drive circuit 600 may include a graphic memory (hereinafter “GRAM”). According to an embodiment, the display drive circuit 600 may reduce current consumption and reduce the load of the processor 500, using the GRAM. The GRAM may write the display data that is input from the processor 500 and output the written data through a scan operation. In an embodiment, the GRAM may be implemented as a dual port DRAM.

According to various embodiments, the display panel 700 may display the display data (RGB data) in units of a frame according to the control of the display drive circuit 600. For example, the display panel 700 may be any one of an organic light emitting diodes (OLED) panel, a liquid crystal display panel (LCD), a plasma display panel (PDP), an electrophoretic display panel, and/or an electrowetting display panel. According to an embodiment, the display panel 700 may be an active matrix organic light emitting diode (AMOLED) display manufactured by a low temperature polysilicon (LTPS) process.

According to an embodiment, in the display panel 700, for example, gate lines (e.g., gate lines G1 to Gn of FIG. 11) and source lines (e.g., source lines S1 to Sm of FIG. 11) may be placed to intersect in the form of a matrix. For example, a gate signal may be supplied to the gate lines, and a signal corresponding to the display data (RGB data) may be supplied to the source lines. The signal corresponding to the display data (RGB data) may be supplied to the source driver (e.g., the source driver 603 of FIG. 11) according to the control of the timing controller 101 of the display drive circuit 600.

FIG. 11 is a diagram which shows the display drive device and display panel according to some embodiments.

Referring to FIG. 11, the display drive device 600 may output display data (RGB data) (or image data stream) to the display panel 700 at a specified refresh rate (or a frame rate or a display drive speed).

According to various embodiments, the display drive device 600 may include a timing controller 601, a gate driver circuit 603, and a source driver circuit 602. The display panel 700 may include a plurality of pixels PX placed along a plurality of gate lines G1 to Gn and a plurality of source lines S1 to Sm.

According to various embodiments, the timing controller 601 may provide a clock signal (e.g., PCLK) for the operation of the gate driver circuit 603 and/or the source driver circuit 603. The timing controller 601 may be a timing controller according to the embodiments of FIGS. 1 to 9.

The gate driver circuit 603 may apply a voltage (e.g., VGH, VGL) to the plurality of gate lines G1 to Gn to drive a switching element (not shown). The source driver circuit 603 may charge the pixels by converting the display data (RGB data) sent as a digital value into an analog value.

In an embodiment, the display drive device 600 may display an image in units of a frame. During the time required to display one frame (hereinafter referred to as scan time), the gate driver circuit 603 may sequentially scan a plurality of gate lines G1 to Gn.

During the time when the gate driver circuit 603 scans each of the plurality of gate lines G1 to Gn, the source driver circuit 603 may input a signal (hereinafter, a data signal) corresponding to the display data (RGB data) to the pixels PX.

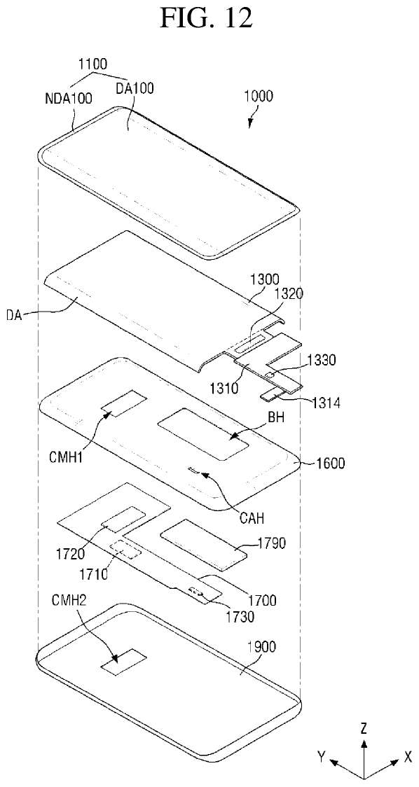

FIG. 12 is an exploded perspective view which shows the display device according to some embodiments.

Referring to FIG. 12, a display device 1000 according to some embodiments may be applied to portable electronic devices such as a mobile phone, a smart phone, a tablet PC (tablet personal computer), a mobile communication terminal, an electronic organizer, an electronic book, a PMP (portable multimedia player), a navigation, and a UMPC (Ultra Mobile PC). Alternatively, the display device 1000 according to some embodiments may be applied as a display unit of a television, a notebook, a monitor, a notice board, or an Internet of Things (JOT). Alternatively, the display device 1000 according to some embodiments may be applied to wearable devices such as a smart watch, a watch phone, an eyeglass-type display, and a head-mounted display (HDM). Alternatively, the display device 1000 according to some embodiments may be applied to an instrument panel of an automobile, a center fascia of an automobile, a CID (Center Information Display) placed on a dashboard of an automobile, or a rearview mirror display substituting for a side mirror of an automobile or a display located behind the front seats as entertainment for the back seats of an automobile.

In the present specification, a first direction (X-axis direction) may be a short side direction of the display device 1000, for example, a horizontal direction of the display device 1000. A second direction (Y-axis direction) may be a long side direction of the display device 1000, for example, a vertical direction of the display device 1000. A third direction (Z-axis direction) may be a thickness direction of the display device 1000.

The display device 1000 according to an embodiment includes a cover window 1100, a display panel 1300, a display circuit board 1310, a display drive circuit 1320, a bracket 1600, and a main circuit board 1700, and a lower cover 1900.

The cover window 1100 may be placed above the display panel 1300 to cover a front surface of the display panel 1300. As a result, the cover window 1100 may serve a function of protecting the front surface of the display panel 1300.

The cover window 1100 may include a penetrating portion DA100 corresponding to the display panel 1300, and a light-shielding portion NDA100 corresponding to an area other than the display panel 1300. The light-shielding portion NDA100 may be formed opaquely. Alternatively, the light-shielding portion NDA100 may be formed of a deco layer formed with a pattern that may be shown to the user when the image is not displayed.

The display panel 1300 may be placed below the cover window 1100. The display panel 1300 may be a light emitting display panel including a light emitting element. For example, the display panel 1300 may be an organic light emitting display panel which uses an organic light emitting diode including an organic light emitting layer, a micro light emitting diode display panel which uses a micro light emitting diode (micro LED), a quantum dot light emitting display panel which uses a quantum dot light emitting diode including a quantum dot light emitting layer, or an inorganic light emitting display panel which uses an inorganic light emitting element including an inorganic semiconductor. Hereinafter, the display panel 1300 will be mainly described as being an organic light emitting display panel.

The display panel 1300 may include a display area DA. The display area DA may occupy the most area of the display area DA. However, although not shown, a sub-display area may be further included on one side (e.g., an upper side) of the display area DA. The sub-display area may be an area in which other components (e.g., a camera lens, a proximity sensor, etc.) are placed.

The display area DA does not include a penetrating area through which light is penetrated and may include only a pixel area including pixels for displaying an image. According to some embodiments, the pixel area may be arranged only in the remaining portion of the sub-display area, except portions in which the camera lens and the sensor are placed. Alternatively, according to some embodiments, the sub-display area may include both the penetrating area through which light is penetrated and the pixel area that includes pixels for displaying an image.

The display circuit board 1310 and the display drive circuit 1320 may be attached to one side of the display panel 1300. The display circuit board 1310 may be a flexible printed circuit board that may be bent, a rigid printed circuit board that is rigid and hard to bend, or a composite printed circuit board that includes both the rigid printed circuit board and the flexible printed circuit board.

The display drive circuit 1320 may receive control signals and power supply voltages through the display circuit board 1310 and generate and output signals and voltages for driving the display panel 1300. Although the display drive circuit 1320 may be formed of an integrated circuit (IC) and may be attached onto the display panel 1300 by a COG (Chip On Glass) type, a COP (Chip On Plastic) type or an ultrasonic type, the embodiment is not limited thereto. For example, the display drive circuit 1320 may be attached onto the display circuit board 1310.

A touch drive circuit 1330 may be placed on the display circuit board 1310. The touch drive circuit 1330 is formed of an integrated circuit and may be attached to the upper surface of the display circuit board 1310. The touch drive circuit 1330 may be electrically connected to the touch electrodes of the touch sensor layer of the display panel 1300 through the display circuit board 1310. The touch drive circuit 1330 may output a touch drive signal to the touch electrodes and sense the voltage charged to the capacitance of the touch electrodes.

The touch drive circuit 1330 generates touch data according to the change of the electric signal sensed by each of the touch electrodes and sends the touch data to the main processor 1710, and the main processor 1710 may analyze the touch data to calculate touch coordinates in which the touch occurs. The touch may include a contact touch and a proximity touch. The contact touch means that an object such as a human finger or a pen comes into direct contact with a cover window placed on the sensor electrode layer. The proximity touch means that an object such as a human finger or pen is located on the cover window to be closely spaced, such as hovering.

Further, a power supply unit for supplying the display drive voltages for driving the display drive circuit 1320 may be further placed on the display circuit board 1310.

According to some embodiments, the display drive circuit or the touch drive circuit may each include an independent timing controller. Alternatively, according to some embodiments, the display drive circuit or the touch drive circuit may share the single timing controller. The timing controller may be implemented as the timing controller described in the embodiments of FIGS. 1 to 11. According to some embodiments, the timing controller includes the wireless communication module 301, may store the setting data received by the wireless communication module 301 in the non-volatile memory device 200 and read the stored setting data, and may transfer and load the setting data read from the non-volatile memory 400 into other IP modules 400. In this case, the data may be firmware of the IP module, SFR information, or data relating to the operation.

A bracket 1600 may be placed below the display panel 1300. The bracket 1600 may include plastic, metal, or both plastic and metal. The bracket 1600 may be formed with a first camera hole CMH1 into which a first camera sensor 1720 is inserted, a battery hole BH in which the battery is placed, and a cable hole CAH through which a cable 1314 connected to the display circuit board 1310 passes. Alternatively, the bracket 1600 may be formed so as not to overlap the camera lens and the sensor in the sub-display area of the display panel 1300.

A main circuit board 1700 and a battery 1790 may be placed below the bracket 1600. The main circuit board 1700 may be a printed circuit board or a flexible printed circuit board.

The main circuit board 1700 may include a main processor 1710, a camera sensor 1720, and a main connector 1730. Further, the main circuit board 1700 may further include a proximity sensor, an illuminance sensor, and an iris sensor.

The camera sensor 1720 is placed on both the upper and lower surfaces of the main circuit board 1700, the main processor 1710 is placed on the upper surface of the main circuit board 1700, and the main connector 1730 may be placed on the lower surface of the main circuit board 1700. Alternatively, the proximity sensor, the illuminance sensor, and the iris sensor described above may be placed on the upper surface of the main circuit board 1700.

The main processor 1710 may control all the functions of the display device 1000. For example, the main processor 1710 may output digital video data to the display drive circuit 1320 through the display circuit board 1310 so that the display panel 1300 displays an image. Further, the main processor 1710 may execute an application instructed by an icon displayed on the user's touch coordinates, after receiving the touch data from the touch drive circuit 1330 and determining the user's touch coordinates. Further, the main processor 1710 may convert the image data input from the camera sensor 1720 into digital video data and output the image data to the display drive circuit 320 through the display circuit board 1310, thereby displaying the image captured by the camera sensor 1720 on the display panel 1300. Further, the main processor 1710 may control the display device 1000 according to the sensor signals that are input from the proximity sensor, the illuminance sensor, and the iris sensor.

The camera sensor 1720 processes an image frame such as a still image or a moving image obtained by the image sensor and outputs the image frame to the main processor 1710. The camera sensor 1720 may be a CMOS image sensor or a CCD sensor. The camera sensor 1720 may be exposed on the lower surface of the lower cover 1900 by the second camera hole CMH2, thereby capturing an object or a background placed below the display device 1000.

A cable 1314 that has passed through the cable hole CAH of the bracket 1600 may be connected to the main connector 1730. As a result, the main circuit board 1700 may be electrically connected to the display circuit board 1310.

The battery 1790 may be placed so as not to overlap the main circuit board 1700 in the third direction (Z-axis direction). The battery 1790 may overlap the battery hole BH of the bracket 1600.

In addition, a mobile communication module capable of sending and receiving a radio signal to and from at least one of a base station, an external terminal, and a server on the mobile communication network may be further mounted on the main circuit board 1700. The radio signal may include various types of data according to the sending and reception of audio signals, video call signals, or text/multimedia messages.

The lower cover 1900 may be placed below the main circuit board 1700 and the battery 1790. The lower cover 1900 may be fastened and fixed to the bracket 1600. The lower cover 1900 may form a lower surface appearance of the display device 1000. The lower cover 1900 may include plastic, metal or both the plastic and the metal.

The lower cover 1900 may be formed with a second camera hole CMH2 through which the lower surface of the camera sensor 1720 is exposed. The position of the camera sensor 1720 and the positions of the first and second camera holes CMH1 and CMH2 corresponding to the first camera sensor 1720 are not limited to the embodiment shown in FIG. 12.

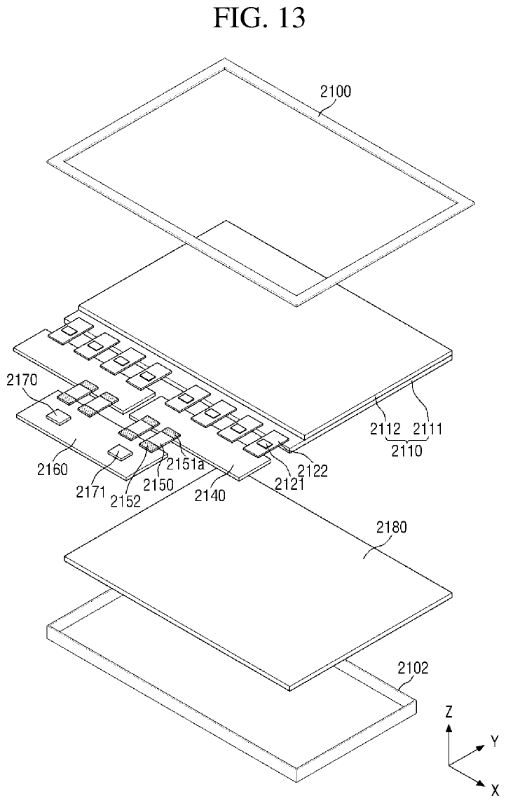

FIG. 13 is a perspective view which shows a display device according to some embodiments.

Referring to FIG. 13, a display device 2000 according to an embodiment includes an upper set cover 2101, a lower set cover 2102, a display panel 2110, source driver circuits 2121, flexible films 2122, a heat dissipation film 2130, source circuit boards 2140, first cables 2150, a control circuit board 2160, a timing controller 2170, and a lower chassis 2180.

In FIG. 13, terms “upper part”, “top”, and “upper surface” refer to a direction in which the second substrate 2112 is placed on the basis of the first substrate 2111 of the display panel 2110, that is, the third direction (Z-axis direction), and terms “lower part”, “bottom”, and “lower surface” refer to a direction in which the heat dissipation film 2130 is placed on the basis of the first substrate 2111 of the display panel 2110, that is, a direction opposite to the third direction (Z-axis direction). Further, terms “left”, “right”, “upper”, and “lower” refer to directions when the display panel 2110 is viewed in a plan view. For example, the term “left” refers to the first direction (X-axis direction), the term “right” refers to a direction opposite to the first direction (X-axis direction), the term “upper” refers to the second direction (Y-axis direction), and the term “lower” refers to a direction opposite to the second direction (Y-axis direction).

The upper set cover 2101 may be placed to cover the edge of the upper surface. The upper set cover 2101 may cover a non-display area except the display area of the display panel 2110. The lower set cover 2102 may be placed below the lower chassis 2180. The lower set cover 2102 may be placed to cover the source circuit boards 2140, the first cables 2150, and the control circuit boards 2160, when the flexible films 2122 are bent and the source circuit boards 2140, the first cables 2150 and the circuit boards 2160 are placed below the display panel 2110. Although FIG. 13 shows an example in which the length of the lower set cover 2102 in the second direction (Y-axis direction) is smaller than the length of the lower chassis 2180 in the second direction (Y-axis direction), the example is not limited thereto. The length of the lower set cover 2102 in the second direction (Y-axis direction) may be larger than the length of the lower chassis 2180 in the second direction (Y-axis direction) or may be substantially the same as the length of the lower chassis 2180 in the second direction (Y-axis direction). The upper set cover 2101 and the lower set cover 2102 may be made of plastic or metal or may include both the plastic and the metal.

The display panel 2110 may be formed in the form of a rectangle in a plan view. For example, the display panel 2110 may have a rectangular plane shape having a long side in the first direction (X-axis direction) and a short side in the second direction (Y-axis direction). A corner at which the long side in the first direction (X-axis direction) and the short side in the second direction (Y-axis direction) intersect may be formed at a right angle or may be formed round to have a predetermined curvature. The planar shape of the display panel 2110 is not limited to a rectangle and may be formed into another polygon, a circle, or an ellipse.

Although the display panel 2110 is shown as being formed to be flat, the present specification is not limited thereto. The display panel 2110 may include a curved surface portion that is bent at a predetermined curvature.

The display panel 2110 may include a first substrate 2111 and a second substrate 2112. The second substrate 2112 may be placed to face a first surface of the first substrate 2111. The first substrate 2111 and the second substrate 2112 may be formed rigidly or flexibly. The first substrate 2111 may be formed of glass or plastic. The second substrate 2112 may be formed of glass, plastic, a sealing film, or a barrier film. Alternatively, the second substrate 2112 may be omitted.

The display panel 2110 may be an organic light emitting display panel which uses an organic light emitting diode including a first electrode, an organic light emitting layer and a second electrode, an inorganic light emitting display panel which uses an inorganic light emitting diode including a first electrode, an inorganic semiconductor layer and a second electrode, or a quantum dot light emitting display panel which includes a quantum dot light emitting diode including a first electrode, a quantum dot light emitting layer, and a second electrode.

One side of each of the flexible films 2122 may be placed on the first surface of the first substrate 2111 of the display panel 2110, and the other side thereof may be attached onto one surface of the source circuit board 2140. Specifically, since the size of the first substrate 2111 is greater than the size of the second substrate 2112, one side of the first substrate 2111 may be exposed without being covered with the second substrate 2112. The flexible films 2122 may be attached to one side of the first substrate 2111 exposed without being covered with the second substrate 2112. Each of the flexible films 2122 may be attached to the first surface of the first substrate 2111 and one surface of the source circuit board 2140, using an anisotropic conductive film.

Each of the flexible films 2122 may be a flexible film such as a tape carrier package or a chip-on-film. The flexible films 2122 may be bent to the lower part of the first substrate 2111, and in this case, the source circuit boards 2140, the first cables 2150, and the control circuit boards 2160 may be placed on the lower surface of the lower chassis 2180. Although FIG. 13 shows an example in which eight flexible films 2122 are attached onto the first substrate 2111 of the display panel 2110, the number of flexible films 2122 is not limited thereto in the present specification. The entirety of the flexible films 2122 may be attached onto the first substrate 2111, and any other number of flexible films may be attached onto the first substrate 2111.

A source driver circuit 2121 may be placed on one surface of the flexible films 2122. The source driver circuits 2121 may be formed by an integrated circuit (IC). Each of the source driver circuits 2121 converts digital video data into analog data voltages according to the source control signal of the timing controller 2170 and supplies the analog data voltages to the data lines of the display panel 2110 through the flexible film 2122.

The display panel 2110 may include scan lines that intersect the data lines and pixels that are placed in the area defined by the data lines and the scan lines. The scan signals may be supplied to the scan lines from a scan drive unit formed on the display panel 2110. The scan drive unit includes a plurality of thin film transistors and may generate scan signals according to the scan control signal of the timing controller 2171. Each pixel is connected to at least one data line and at least one scan line, and when a scan signal is supplied to the scan line, the data voltage of the data line is supplied to each pixel.

Each of the source circuit boards 2140 may be connected to the control circuit board 2160 through a first cable 2150. Each of the source circuit boards 2140 may include a first connector 2151a for being connected to the first cables 2150. The source circuit boards 2140 may be a flexible printed circuit board or a printed circuit board. The first cables 2150 may be flexible cables.

The control circuit board 2160 may be connected to the source circuit boards 2140 through the first cables 2150. For this purpose, the control circuit board 2160 may include second connectors 2152 for being connected to the first cables 2150. The control circuit board 2160 may be fixed to one surface of the lower chassis 2180 through a fixing member such as a screw. The control circuit board 2160 may be a flexible printed circuit board or a printed circuit board.

The timing controller 2170 described in reference to FIGS. 1 to 11 may be placed on one surface of the control circuit board 2160. The control circuit board 2160 may be called a display drive circuit board. The timing controller 2170 may be formed by an integrated circuit. The timing controller 2170 may receive digital video data and timing signals from the system-on-chip of the system circuit board and generate a source control signal for controlling the timings of the source driver circuits 2121 according to the timing signals. The timing controller 2170 may be implemented as the timing controller described in the embodiments of FIGS. 1 to 11. According to some embodiments, the timing controller 2170 includes the wireless communication module 301, may store the setting data received by the wireless communication module 301 in the non-volatile memory device 200, read the stored setting data, and transfer and load the setting data read from the non-volatile memory device 400 to other IP modules 400. At this time, the data may be firmware of the IP module, SFR information, or data relating to operation.

The system-on-chip may be attached onto a system circuit board connected to the control circuit board 2160 through a flexible cable and may be formed by an integrated circuit. The system-on-chip may be a smart TV processor, a central processing unit (CPU) or graphic card for a computer or notebook, or an application processor of a smart phone or a tablet PC. The system circuit board may be a flexible printed circuit board or a printed circuit board.

A power supply circuit may be further bonded onto one surface of the control circuit board 2160. The power supply circuit may generate voltages necessary for driving the display panel 2110 from the main power supply applied from the system circuit board and supply the voltages to the display panel 2110. For example, the power supply circuit may generate a high potential voltage, a low potential voltage, and an initialization voltage for driving the organic light emitting element and supply them to the display panel 2110. Further, the power supply circuit may generate and supply the drive voltages for driving the source driver circuits 2121, the timing controller 2170, and the like. The power supply circuit may be formed as an integrated circuit. Alternatively, the power supply circuit may be placed on a power supply circuit board formed separately in addition to the control circuit board 2160. The power circuit board may be a flexible printed circuit board or a printed circuit board.

The lower chassis 2180 may be placed on the second surface of the first substrate 2111. The lower chassis 2180 may be metal or tempered glass.

On the other hand, although FIG. 13 shows that the display device 2000 according to the embodiment is a medium and large display device including a plurality of source driver circuits 2121, the disclosure is not limited thereto. That is, the display device 2000 according to an embodiment may be a small display device including the single source driver circuit 2121. Examples of the medium and large display devices include a monitor, a television and the like, and examples of the small display devices include a smart phone, a tablet PC and the like.

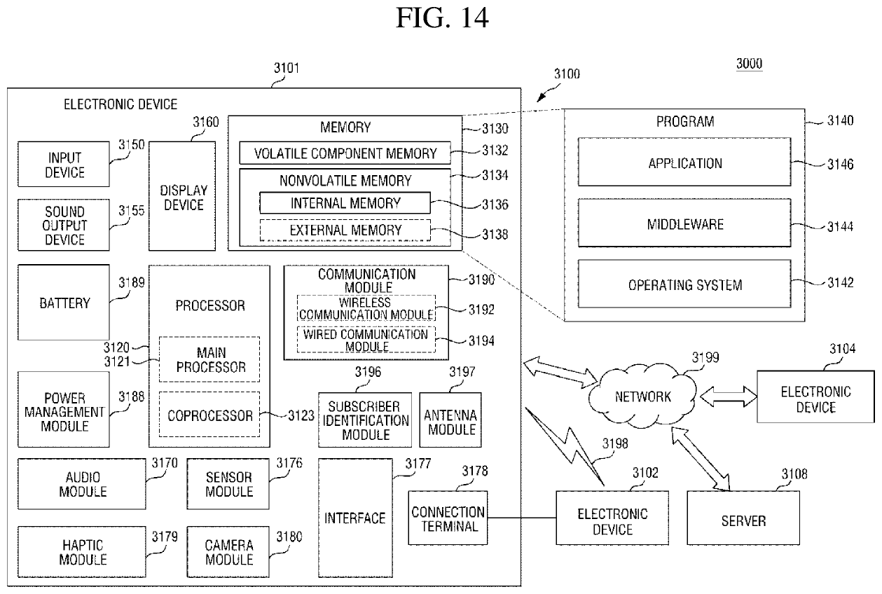

FIG. 14 is a block diagram of an electronic device in a network environment 3000 according to some embodiments.

Referring to FIG. 14, in the network environment 3000, an electronic device 3101 may communicate with an electronic device 3102 through a first network 3198 (e.g., short-range wireless communication network) or may communicate with an electronic device 3104 or a server 3108 through a second network 3199 (e.g., long-range wireless communication network). According to an embodiment, the electronic device 3101 may communicate with the electronic device 3104 through the server 3108. According to an embodiment, the electronic device 3101 may include a processor 3120, a memory 3130, an input device 3150, a sound output device 3155, a display device 3160, an audio module 3170, a sensor module 3176, an interface 3177, a haptic module 3179, a camera module 3180, a power management module 3188, a battery 3189, a communication module 3190, a subscriber identification module 3196, and an antenna module 3197. In some embodiments, at least one of these components (e.g., the display device 3160 or the camera module 3180) may be omitted from the electronic device 3101 or one or more other components may be added to the electronic device 3101. In some embodiments, some of these components may be implemented as an integrated circuit. For example, the sensor module 3176 (e.g., a fingerprint sensor, an iris sensor, or an illuminance sensor) may be implemented, while being embedded in the display device 3160 (e.g., a display).

The processor 3120 may control at least one other component (e.g., hardware or software component) of the electronic device 3101 connected to the processor 3120 and may perform various data processing or computations, for example, by executing software (e.g., program 3140). According to an embodiment, as at least a part of data processing or computation, the processor 3120 may load instructions or data received from other components (e.g., the sensor module 3176 or the communication module 3190) to the volatile memory 3132, process the instructions or data stored in the volatile memory 3132, and store the result data in the non-volatile memory 3134. According to an embodiment, the processor 3120 may include a main processor 3121 (e.g., a central processing unit or application processor) and an auxiliary processor 3123 that can operate independently of or together with the main processor 3121 (e.g., a graphic processing device, an image signal processor, a sensor hub processor or a communication processor). Additionally, or alternatively, the auxiliary processor 3123 may use lower power than the main processor 3121 or may be set to be specialized for a designated function. The auxiliary processor 3123 may be implemented separately from or as a part of the main processor 3121.

The auxiliary processor 3123 may control at least some of the functions or statuses related to at least one component (e.g., the display device 3160, the sensor module 3176, or the communication module 3190) among the components of the electronic device 3101, for example, on behalf of the main processor 3121 while the main processor 3121 is in an inactive (e.g., sleep) status or along with the main processor 3121 while the main processor 3121 is in an active (e.g., application execution) status. According to an embodiment, the auxiliary processor 3123 (e.g., image signal processor or communication processor) may be implemented as a part of functionally related other components (e.g., the camera module 3180 or the communication module 3190).

The memory 3130 may store various data used by at least one component (e.g., the processor 3120 or the sensor module 3176) of the electronic device 3101. The data may include, for example, input data or output data for software (e.g., program 3140) and instructions related thereto. The memory 3130 may include a volatile memory 3132 or a non-volatile memory 3134.

The program 3140 may be stored as software in the memory 3130 and may include, for example, an operating system 3142, a middleware 3144 or an application 3146.

The input device 3150 may receive instructions or data used by the components (e.g., the processor 3120) of the electronic device 3101 from the outside (e.g., the user) of the electronic device 3101. The input device 3150 may include, for example, a microphone, a mouse or a keyboard.

The sound output device 3155 may output a sound signal to the outside of the electronic device 3101. The sound output device 3155 may include, for example, a speaker or a receiver. The speaker may be used for general purposes such as multimedia playback or recording and playback, and the receiver may be used to receive an incoming call. According to an embodiment, the receiver may be implemented separately from or as a part of the speaker.

The display device 3160 may visually provide information to the outside (e.g., a user) of the electronic device 3101. The display device 3160 may include, for example, a display, a hologram device or a projector and a control circuit for controlling that device. According to an embodiment, the display device 3160 is a touch circuitry which is set to sense the touch or a sensor circuitry (e.g., a pressure sensor) which is set to measure the strength of the force generated by the touch. The display device 3160 may be a display device including the semiconductor integrated circuit of FIGS. 1 to 11 described above.

The audio module 3170 may convert sound into an electrical signal or vice versa. According to an embodiment, the audio module 3170 may acquire sound through the input device 3150 or may output sound through the sound output device 3155 or an external electronic device (e.g., the electronic device 3102) (e.g., a speaker or a headphone) that is directly or wirelessly connected to the electronic device 3101.

The sensor module 3176 senses an operating status (e.g., power or temperature) of the electronic device 3101 or an external environmental status (e.g., a user status) and may generate an electrical signal or data value corresponding to the sensed status. According to an embodiment, the sensor module 3176 may include, for example, a gesture sensor, a gyro sensor, an atmospheric pressure sensor, a magnetic sensor, an acceleration sensor, a grip sensor, a proximity sensor, a color sensor, an IR (infrared) sensor, a biosensor, a temperature sensor, a humidity sensor or an illuminance sensor.

The interface 3177 may support one or more specified protocols that may be used for connecting the electronic device 3101 directly or wirelessly to an external electronic device (e.g., the electronic device 3102). According to an embodiment, the interface 3177 may include, for example, a high resolution multimedia interface (HDMI), a universal serial bus (USB) interface, an SD card interface or an audio interface.

The connection terminal 3178 may include a connector through which the electronic device 3101 may be physically connected to an external electronic device (e.g., the electronic device 3102). According to an embodiment, the connection terminal 3178 may include, for example, an HDMI connector, a USB connector, an SD card connector or an audio connector (e.g., a headphone connector).

The haptic module 3179 may convert an electrical signal into a mechanical stimulus (e.g., vibration or motion) or an electrical stimulus that may be perceived by the user through sense of touch or kinesthetic sensations. According to an embodiment, the haptic module 3179 may include, for example, a motor, a piezoelectric element or an electrical stimulator.

The camera module 3180 may capture still images and moving images. According to an embodiment, the camera module 3180 may include one or more lenses, image sensors, image signal processors or flashes.

The power management module 3188 may manage the power to be supplied to the electronic device 3101. According to an embodiment, the power management module 3188 may be implemented, for example, as at least a part of a power management integrated circuit (PMIC).

The battery 3189 may supply power to at least one component of the electronic device 3101. According to an embodiment, the battery 3189 may include, for example, a non-rechargeable primary battery, a rechargeable secondary battery or a fuel cell.

The communication module 3190 may support establishment of a direct (e.g., wired) communication channel or a wireless communication channel between the electronic device 3101 and the external electronic device (e.g., the electronic device 3102, the electronic device 3104 or the server 3108) and the execution of communication through the established communication channel. The communication module 3190 may include one or more communication processors that operate independently of the processor 3120 (e.g., an application processor) and support direct (e.g., wired) communication or wireless communication. According to an embodiment, the communication module 3190 may include a wireless communication module 3192 (e.g., a cellular communication module, a short-range wireless communication module or a GNSS (global navigation satellite system) communication module) or a wired communication module 3194 (e.g., LAN (local area network) communication module or a power line communication module). Among these communication modules, the corresponding communication module may communicate with the external electronic device through the first network 3198 (e.g., a short-range wireless communication network such as Bluetooth, WiFi direct, or IrDA (infrared data association)) or the second network 3199 (e.g., a long-range wireless communication network such as a cellular network, Internet or a computer network (e.g., LAN or WAN)). Various types of communication modules may be integrated into a single component (e.g., a single chip) or may be implemented as a plurality of separate components (e.g., a plurality of chips). The wireless communication module 3192 may verify and authenticate the electronic device 3101 inside a communication network such as the first network 3198 or the second network 3199, using subscriber information (e.g., International Mobile Subscriber Identifier (IMSI)) stored in the subscriber identification module 3196. The wireless communication module 3192 may be the wireless communication module described in FIG. 8.

The antenna module 3197 may send or receive signals or power to and from the outside (e.g., the external electronic device). According to an embodiment, the antenna module 3197 may include one or more antennas, and hence, at least one antenna which is suitable for a communication system used in communication networks such as the first network 3198 or the second network 3199 may be selected, for example, by the communication module 3190. The signal or power may be sent or received between the communication module 3190 and the external electronic device through at least one selected antenna.

At least some of the components are connected to each other through communication systems between peripheral devices (e.g., a bus, a GPIO (general purpose input and output), a SPI (serial peripheral interface) or a MIPI (mobile industry processor interface)), and may exchange signals (e.g., instructions or data) with each other.

The electronic devices according to various embodiments disclosed herein may be various forms of devices. The electronic devices may include, for example, a portable communication device (e.g., a smart phone), a computer device, a portable multimedia device, a portable medical device, a camera, a wearable device or a home appliance. The electronic device according to the embodiment of the present specification is not limited to the above-mentioned device.

As used herein, the term “module” may include a unit implemented as hardware, software or firmware, and may be used to be compatible with terms such as logic, logical block, component or circuit. The module may be an integrally formed component or the smallest unit or part of a component that performs one or more functions. For example, according to an embodiment, the module may be implemented in the form of an application-specific integrated circuit (ASIC).

Various embodiments of the present specification may be implemented as software (e.g., program 3140) including one or more instructions stored in a storage medium (e.g., the internal memory 3136 or the external memory 3138) that is readable by a machine (e.g., the electronic device 3101). For example, the processor (e.g., the processor 3120) of the machine (e.g., the electronic device 3101) may call and execute at least one instruction of one or more stored instructions from the storage medium.

The methods according to the embodiments described in the claims or specification of the present disclosure may be implemented in the form of hardware, software or a combination of hardware and software.

When implemented as software, a computer-readable storage medium for storing one or more programs (software modules) may be provided. One or more programs stored in the computer-readable storage medium are configured to be executable by one or more processors inside the electronic device. One or more programs include instructions which cause the electronic device to perform the method according to the embodiments described in the claims or specification of the present disclosure.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. An aspect of an embodiment may be achieved through instructions stored within a non-transitory storage medium and executed by a processor.

In concluding the detailed description, those skilled in the art will appreciate that many variations and modifications may be made to the preferred embodiments without substantially departing from the principles of the disclosure. Therefore, the disclosed preferred embodiments are used in a generic and descriptive sense only and not for purposes of limitation.

1. A display drive device comprising:
a first intellectual property (IP) module;
a second IP module;
a timing controller which includes a wireless communication module that is wirelessly connected to a test device and sends and receives setting data and stops a currently executing operation and sends the setting data when receiving the setting data; and
a non-volatile memory which stores the setting data received from the timing controller.

2. The display drive device of claim 1, wherein the timing controller checks whether there is an error in setting data stored in the non-volatile memory.

3. The display drive device of claim 1, wherein the setting data includes header information including a target address, body information including data to be written in the non-volatile memory, and cyclic redundancy check (CRC) information.

4. The display drive device of claim 1, wherein the wireless communication module performs communication by Bluetooth™, WiFi Direct, near field communication (NFC), Zigbee™, Z-wave™, 6LoWPAN™, or infrared data association (IrDA).

5. The display drive device of claim 1, wherein the display drive device is connected to:
an organic light emitting display panel which uses an organic light emitting diode including a first electrode, an organic light emitting layer, and a second electrode,
an inorganic light emitting display panel which uses an inorganic light emitting diode including a first electrode, an inorganic semiconductor layer, and a second electrode, or
a quantum dot light emitting display panel which includes a quantum dot light emitting diode including a first electrode, a quantum dot light emitting layer, and a second electrode to drive the display panel.

6. The display drive device of claim 1, wherein:
the wireless communication module checks a user authority of the test device, when receiving an access signal of the test device,
the wireless communication module performs pairing with the test device and receives the setting data from the test device, when the user authority is approved, and
the wireless communication module checks address information included in a header of the setting data and sends the setting data to the first IP module or second IP module corresponding to the address information.

7. The display drive device of claim 1, wherein the timing controller reads the setting data stored in the non-volatile memory and sends the setting data to the first IP module.

8. The display drive device of claim 7, wherein:
the IP module updates settings based on the setting data received from the timing controller, and
the IP module performs a normal operation based on the updated settings after chip rebooting.

9. The display drive device of claim 1, wherein the setting data includes firmware of the timing controller, SFR (Special Function Register) information of the display drive device, or operational information of the first IP module or the second IP module.

10. A test device comprising:
a wireless communication module which wirelessly communicates with a timing controller in a display drive device, wherein
the wireless communication module sends setting data to the timing controller, receives reply data from the timing controller, and checks a test result.

11. The test device of claim 10, wherein the reply data includes firmware of the display drive device, SFR (Special Function Register) information, or operational information of an IP included in the display drive device.

12. A semiconductor integrated circuit comprising:
a timing controller which wirelessly sends and receives setting data from a test device; and
a non-volatile memory which receives and stores the setting data from the timing controller.

13. The semiconductor integrated circuit of claim 12, wherein the timing controller further includes a control logic which accesses the non-volatile memory based on header information of the setting data.

14. The semiconductor integrated circuit of claim 13, wherein the control logic sends a read request to the non-volatile memory, receives setting data corresponding to the read request from the non-volatile memory, and sends the setting data to an intellectual property (IP) module.

15. The semiconductor integrated circuit of claim 12, wherein:
the timing controller stops a currently executing operation, when receiving an access signal of the test device,
the timing controller updates settings based on the setting data, and
the timing controller performs a normal operation based on the updated settings after chip rebooting.

16. The semiconductor integrated circuit of claim 15, wherein the timing controller reads initial data that is pre-stored in the non-volatile memory and sends the initial data to an intellectual property (IP) module, when the rebooting fails.

17. The semiconductor integrated circuit of claim 12, wherein the semiconductor integrated circuit is a display drive device or a touch drive device.

18. The semiconductor integrated circuit of claim 12, wherein:
the timing controller checks a user authority of the test device, when receiving an access signal of the test device,
the timing controller stops a currently executing operation, when the user authority is approved, and
the timing controller is paired with the test device to receive the setting data.

19. The semiconductor integrated circuit of claim 18, wherein:
the timing controller sends the setting data to the non-volatile memory, and
the timing controller performs a cyclic redundancy check (CRC) check of the setting data which is sent to and stored in the non-volatile memory.

20. The semiconductor integrated circuit of claim 19, wherein the timing controller sends a CRC result of the setting data or operational information of the semiconductor integrated circuit to the test device as reply data.

21-22. (canceled)
